(19) United States
(12) Patent Application Publication
(10) Pub. No.: US 2022/0068046 A1
(43) Pub. Date: Mar. 3, 2022

(54) Method for Determining Tolerances of Components or Assemblies

(71) Applicant: ZF Friedrichshafen AG, Friedrichshafen (DE)

(72) Inventors: Joachim Straub, Kressbronn (DE); Alexander Hoffmann, Lebach (DE)

(21) Appl. No.: 17/414,987

(22) PCT Filed: Dec. 18, 2019
(86) PCT No.: PCT/EP2019/085825

§ 371 Date: Jun. 17, 2021

(30) Foreign Application Priority Data
Dec. 20, 2018 (DE) 10 2018 222 519.2

(51) Int. Cl. G07C 5/00; G01B 21/16

(52) U.S. Cl. CPC G07C 5/008; G01B 21/16

(57) ABSTRACT

A system and to a method for determining tolerances of components or assemblies includes at least periodically monitoring the components or assemblies of motor vehicles (5.1-5.6) of the same type during a driving operation and, in the process, metrologically gathering condition data (10) characteristic for tolerances at the components or assemblies, transiting the condition data (10) via existing, wireless communication paths to a central computer (1) or a cloud (2), storing the condition data (10) in the central computer (1) or the cloud (2) with a specific identifier for the individual motor vehicle (5.1-5.6), analyzing the stored condition data in a data processing unit (3), computing actual values of the tolerances existing at the detected motor vehicles (5.1-5.6) from the stored condition data, and determining generally valid variables of the component or assembly sizing on the basis of the actual values for the particular vehicle type (5).

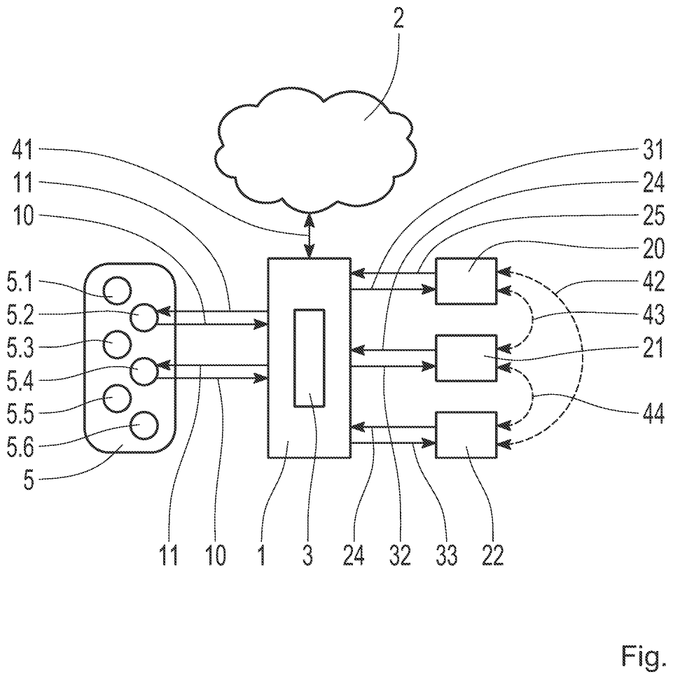

### CROSS-REFERENCE TO RELATED APPLICATIONS

The present application is related and has right of priority to German Patent Application No. 102018222519.2 filed in the German Patent Office on Dec. 20, 2018 and is a nationalization of PCT/EP2019/085825 filed in the European Patent Office on Dec. 18, 2019, both of which are incorporated by reference in their entirety for all purposes.

### FIELD OF THE INVENTION

The invention relates generally to a method for determining tolerances of components or assemblies, in which the components or assemblies of motor vehicles of the same type are at least periodically monitored during a driving operation and, in the process, condition data are metrologically gathered.

The invention further relates generally to a system for determining tolerances of components or assemblies, which at least periodically monitors the components or assemblies of motor vehicles of the same type during a driving operation and, in the process, gathers condition data.

### BACKGROUND

Modern, wireless communication paths make it possible for individual motor vehicles, for example, passenger cars or trucks, to carry out monitoring during a driving operation by sensor systems present in the vehicle, gather vehicle condition data in this way, and make these data available, via the existing communication paths, for central monitoring and analysis. The monitoring and analysis can take place via a central computer of the particular vehicle manufacturer, for example, as described in EP 2 607 144 A1. Operating conditions of the vehicle can be detected on the basis of the vehicle condition data and, therefrom, instructions for the driver can be derived. For example, it can be reported to the driver that his/her vehicle requires service, also outside the established service intervals.

The knowledge of the current vehicle condition data can also be of interest to vehicle manufacturers and their suppliers. It is in their interest to be able to manufacture the vehicles and/or their supplied components as cost-effectively as possible. An important cost factor in production and manufacturing are the tolerances of the utilized components, assemblies, which are usually specified and are utilized in production, or even the tolerances in the interaction of components or assemblies. Often, the tolerances apply equally for all component groups, are based on assumptions, and, therefore, are not actually specified according to demand. The observation of excessively narrow tolerances in production and manufacturing generates costs and complexity and can be uneconomical.

If problems arise due to component deviations in the on-going production, decisions often cannot be reached, as necessary, for each component or each component group separately, since all the information necessary for making decisions regarding optimal tolerances is often unavailable.

### BRIEF SUMMARY OF THE INVENTION

Example aspects of the invention, therefore, utilize additional sources of information in the determination of mandatory variables of the component sizing and of the assembly sizing and, as a result, arrive at a better prediction with regard to variable-related variations in the component sizing and the assembly sizing that are still permissible. Example aspects of the invention determine tolerances that are situated as close as possible to the optimum between low costs, on the one hand, and increased susceptibility for subsequent wear or failure rate, on the other hand.

In the method:
the components or assemblies of vehicles or motor vehicles of the same type are at least periodically monitored during a driving operation and, in the process, condition data are metrologically gathered, which are characteristic for tolerances at the components or assemblies;
the condition data are transmitted via existing, wireless communication paths to a central computer or a cloud and stored therein together with a specific identifier for the individual vehicle; and
the stored condition data are analyzed in a data processing unit, actual values of the tolerances existing at the detected vehicles are computed therefrom, and generally valid variables of the component or assembly sizing are determined on the basis of the actual values, gathered in this way, for the particular vehicle type.

Additional sources of information are therefore utilized for determining mandatory variables of the component sizing and of the assembly sizing, in order to thereby arrive at a better prediction with regard to variable-related variations in the component and assembly sizing that are still permissible. Tolerances can therefore be derived that are situated close to the optimum between low costs, on the one hand, and increased susceptibility for subsequent wear or failure rate, on the other hand.

A field monitoring of vehicles takes place insofar as not only a single vehicle, but rather a plurality of further vehicles of the same vehicle type is subject to at least one periodic monitoring. The same vehicle type or vehicles of the same type is/are intended to mean motor vehicles, in which these or identical components and/or assemblies are also installed.

By sensor systems present in the vehicle, condition data are monitored, that are characteristic for the tolerances of the components, assemblies or for tolerances in the interaction of components or assemblies. This can be, for example, a relative mobility of the components with respect to each other, or vibration characteristics of the components, or acoustic behavior of the components or other metrologically detectable properties, the knowledge and analysis of which allow for inferences to be drawn regarding the mechanical or even control-related tolerances of individual vehicle parts or groups of vehicle parts.

An example preferred application involves the components of the vehicle drive train, primarily the transmission and the clutch of the vehicle and the tolerances at the components and component groups of the transmission and the clutch.

The monitoring and gathering of the condition data takes place by sensors or on-board devices of the vehicles, and takes place either at shorter or longer time intervals, i.e., periodically. It is also possible to carry out an on-going and, thereby, continuous monitoring when there is an appropriately larger data volume.

The condition data gathered directly in the particular vehicle in this way are transmitted via existing, wireless communication paths to the central computer or the cloud. The assignment of the transmitted condition data to a certain vehicle is important. In order to be able to assign the gathered data to certain components installed in the vehicle, the condition data are stored in the central computer or the cloud together with an identifier unique to the particular vehicle.

The specific identifier can be, for example, a vehicle-specific digital code, if applicable, supplemented with a code that stands for the particular vehicle type or for a certain monitored component in the vehicle, for example, for the transmission or clutch unit specifically installed in the vehicle.

The data processing unit, which can be an integral part of the central computer or communicates therewith or with the cloud, analyzes the stored condition data. On the basis thereof, actual values of the existing tolerances at the monitored transmission or clutch units are computed in the data processing unit. As much gathered condition data as possible should be incorporated into the calculations, since the tolerance behavior of components or assemblies of vehicles is also usually subject to many influence factors.

In the system, generally valid variables of the component or assembly sizing are determined for the relevant vehicle type on the basis of all actual tolerances computed in this way.

Such generally valid variables can be, for example, component dimensions, primarily, however, tolerances and tolerance ranges related to the technical variables or sizings to be observed in production and manufacturing. A movement play, primarily with respect to vehicle transmissions or clutches, can also be the object of the tolerance determination and specification.

The data processing unit can also access production data related to the vehicle type, or technical data of supplied components or assemblies related to the vehicle type in the determination of generally valid variables of the component and/or assembly sizing.

The data processing unit can also access technical setting data related to the vehicle type in the determination of generally valid variables of the component and/or assembly sizing.

The data processing unit can also access workshop and service data related to the vehicle type in the determination of generally valid variables of the component and/or assembly sizing.

The data processing unit can also access test stand data related to the vehicle type and data from type-specific series of tests in the determination of generally valid variables of the component and/or assembly sizing.

The data processing unit can also access data regarding the production period and the production lot related to individual vehicles of the vehicle type in the determination of generally valid variables of the component and/or assembly sizing.

The data processing unit can also access data regarding the running period or the operating hours of the vehicle related to individual vehicles of the vehicle type in the determination of generally valid variables of the component and/or assembly sizing.

The data processing unit can also access technical setting data related to individual vehicles of the vehicle type in the determination of generally valid variables of the component and/or assembly sizing.

The communication paths can also include an information transmission of operation settings from the central computer or the cloud to individual vehicles, in order to implement operation settings or change operation settings at the vehicles. The implementation or the change of the operation settings can be preceded by a release function, to which the vehicle user has access. For example, the vehicle user has access to the release function via an app.

### BRIEF DESCRIPTION OF THE DRAWING

An exemplary embodiment of the invention is explained in greater detail in the following with reference to the diagrammatic figure, wherein identical or similar elements are labeled with the same reference character. The sole FIGURE shows a system diagram for a method according to example aspects of the invention for determining tolerances of components and assemblies.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

Vehicles 5.1-5.6, namely vehicles 5.1, 5.2, 5.3, 5.4, 5.5, and 5.6, equipped with identical components or assemblies form a vehicle fleet 5. These motor vehicles 5.1-5.6 are provided with capturing units such as, for example, sensors, with which condition data can be gathered at the installed components and/or assemblies. Via existing, wireless communication paths such as, for example, telematics, the condition data 10 from the individual vehicle 5.1-5.6 reach a central computer 1, which, for its part, can communicate with a cloud 2 via a data exchange 41.

Even though, primarily, condition data 10 from the individual motor vehicles 5.1-5.6 reach the central computer 1, an opposite data path is also present, via which the central computer transmits adaptation data 11 to the vehicle fleet 5 and, preferably, directly to the individual motor vehicles 5.1-5.6, in order to change operation settings in the particular motor vehicle 5.1-5.6 there.

The central computer 1 is also in data exchange with mobile services, for example, Customer Service 20 of the vehicle manufacturer. This is the case because data characteristic for tolerances are also available there, and the data characteristic for tolerances are also called up by the central computer 1. Similarly, Development 21 and Production 22 also deliver data, for example, data from components or assembly groups 24, for transmission to the central computer 1 and incorporation into the evaluation and analysis. Customer Service 20 can also transmit further necessary data 25 to the central computer 1.

For this purpose, a data processing unit 3 is an integral part of the central computer 1, the processor of which analyzes the stored vehicle condition data 10 and the further data, for example, of Customer Service 20, Development 21, and Production 22, computes, on the basis thereof, the real, existing actual tolerances in the components of the individual motor vehicles 5.1-5.6, and determines generally valid variables of the component or assembly sizing for the particular vehicle type 5 on the basis of the actual tolerances computed in this way for a plurality of motor vehicles 5.1-5.6.

The variables determined in this way, in the form of specifications or recommendations 31 from the data processing unit 3 in the central computer 1, then reach for example, Customer Service 20. Or the variables reach Vehicle Development 21 in the form of recommended functionalities 32, or, in the form of recommended measures 33, the variables reach Vehicle Production 22 at the vehicle manufacturer itself, or its suppliers. Vehicle Production 22 can communicate with Customer Service 20 via a data exchange 42. Moreover, Customer Service 20 can communicate with Development 21 via a data exchange 43. Moreover, Vehicle Production 22 can communicate with Development 21 via a data exchange 44.

By the observation mode, for example, transmission shifts and the shift quality can be determined via field observation, and the data can be made available via the central computer 1 or the cloud 2 to the data processing unit 3, which is located, for example, at the vehicle manufacturer or its supplier. The information should converge, in particular, in Production or in Production Control. This makes it possible to specify there, via an intelligent data evaluation, an optimized tolerance for each component within the scope of achieving an optimum with respect to costs and quality.

Inferences are drawn regarding the optimal size of the tolerances via a data exchange with Transmission Production at the vehicle manufacturer or at its suppliers. This opens up the possibility, without disadvantages related to function, wear, or service life, of not only narrowing previously utilized tolerances, but rather also of expanding these, depending on the result of the analysis, in order to lower the manufacturing or production costs. Since the motor vehicles 5.1-5.6 are monitored during operation in the field, i.e., during a driving operation, it is also possible to adequately respond to deviations in the overall field of the operated motor vehicles 5.1-5.6.

The operated method and system are based on the assumption that the possibilities of the data exchange will also increase extraordinarily in the future and no technical limits are foreseeable here.

In one example embodiment, it is possible to arrive at a mutual learning between the vehicle fleet and Production 22 at the vehicle manufacturer or its suppliers on the basis of the gathered vehicle condition data 10 and their analysis. For example, data regarding the shift quality of the transmission shift are advantageous in the evaluation. In the processor of the data processing unit 3, computation yields which components of the transmission are at the limit of the previously specified tolerances, and at which components tolerance play still exists, and so cost-savings effects are possible there.

Spot checks in the vehicle fleet reduce the risk of an erroneous tolerance expansion. The communication paths also include, for example, the transmission of vehicle operation settings and adaptation data 11 from the central computer 1 or the cloud 2 to the individual vehicle 5.1-5.6, in order to thereby implement or change operation settings at the individual vehicle.

Therefore, individual assemblies of the vehicle operated in the field, for example, transmissions or transmission control units, are influenced by way of a spot check via the central computer 1 or the cloud 2, in order to draw inferences regarding the actual sensitivity with respect to tolerances. Such tolerances can be component variables or, in the case of vehicle clutches, even the existing and the necessary air gaps in multi-disk clutches.

For example, it can be determined, via testing, how sensitive the charging of a clutch is by increasing and decreasing, step by step, the rapid charging time while simultaneously detecting and, thereby, observing the shift quality. As a function of the result, a generally valid variable of the relevant sizing can be determined for the future. For example, the air gap can be expanded in Production 22, but also narrowed if an over-tolerancing is detected.

The determined test results are also applied for the future production, for example, in a portion of the vehicle fleet, only after a positive verification is obtained via the metrologically checked handling characteristics of the individual motor vehicle 5.1-5.6. The new tolerance is generally established and/or determined, in that, for example, the appropriate measures are implemented in Production 22 only when a positive verification of the measure is also present from this portion of the vehicle fleet on the basis of the data gathered there.

Due to the targeted use of production data, for example, data of Transmission Production, quality-relevant condition data can be observed and, in this way, inferences can be drawn regarding the quality of the installed components and their usability in the case of an assumed tolerance deviation. Information that is evaluated is information related to products or product lots of suppliers, for example, lined disks for clutches, in order to draw inferences regarding friction value progressions, setting values of components, for example, the air gap of a clutch, and information from the final test stand.

Tolerances in production are mostly variable in the sense that a larger group of components processed one after the other has the same tolerances, in particular for the case in which these parts originated from the same production lot. For example, identical lots of clutch disks have a comparable progression of the friction values. Changes in the tolerances therefore have identical effects for all parts.

The gathered vehicle condition data 10 are collected and stored in the central computer 1, for example, at the vehicle manufacturer, or in the cloud 2. Preferably, a virtual twin is stored in the central computer 1 for each affected component of the motor vehicle 5.1-5.6, for example, of the vehicle transmission. This virtual twin exactly reflects the conditions at the actually existing motor vehicle 5.1-5.6, from which the data originate. The continuous updating of the vehicle condition data 10 takes place in the central computer 1 and/or in the cloud 2, preferably by utilizing further information from the vehicle fleet, from Production 22 such as, for example, Transmission Production, Customer Service 20, and/or Development 21.

In the central computer 1, the data are processed, analyzed, and relationships are ascertained. The central computer 1 derives functions or algorithms therefrom, or even inferences or recommendations for measures to be taken. The measures can be direct measures of a technical nature, or, initially, recommendations for a group of decision-makers. Techniques from the field of artificial intelligence can also be utilized in the data analysis and evaluation.

A recommendation or recommended measure can be the narrowing or the expansion of a tolerance, or the adoption of the change for the future production.

In order to reach conclusions with regard to tolerance expansions, monitoring is carried out up to the end of the service life of the particular motor vehicle 5.1-5.6 or of the vehicle component. The queried vehicle condition data 10 are therefore stored under consideration of the operational life of the particular vehicle component, and are then available as the basis for making a decision regarding the tolerance adjustment. These data are, for example:
current adaptation values;
with regard to transmission shifts, information regarding the shift quality in the vehicles in the field test;
mileage or period of operation of the vehicle;
environmental information such as, for example, ambient temperature, atmospheric humidity, air pressure or altitude, in which the vehicle moves; and
with regard to transmissions and clutches, the number of shifts.

A tolerance adjustment carried out by determining changed, generally valid variables of the component or assembly sizing is not useful when problems are known that are associated with the previous tolerances. In order not to make any claims regarding a tolerance expansion in such a case, information regarding the individual vehicles 5.1-5.6 with respect to current problems is also stored in the cloud or in the central computer 1. These can be, for example, current problems with the quality, problems with certain components, failures and their point in time, for example, due to kilometers traveled, or even wear-related data and the point in time or the mileage when the problems occurred.

The stored vehicle condition data 10 can be anonymized by encryption, in order to be usable only by the authorized user.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 central computer
2 cloud
3 data processing unit
5 vehicle type
5.1 motor vehicle
5.2 motor vehicle
5.3 motor vehicle
5.4 motor vehicle
5.5 motor vehicle
5.6 motor vehicle
10 condition data
11 adaptation data

### 20 Customer Service

### 21 Development

### 22 Production

24 data from components or assemblies.
25 data
31 specifications or recommendations
32 recommended functionalities
33 measures
41 data exchange
42 data exchange
43 data exchange
44 data exchange

1-13. (canceled)

14. A method for determining tolerances of components or assemblies, comprising:
at least periodically monitoring the components or assemblies of motor vehicles (5.1-5.6) of the same type during a driving operation in order to metrologically gather condition data (10) characteristic for tolerances at the components or assemblies;
transmitting the condition data (10) via existing, wireless communication paths to a central computer (1) or a cloud (2);
storing the condition data (10) within the central computer (1) or the cloud (2) together with a specific identifier for the individual vehicle (5.1-5.6); and
analyzing the stored condition data in a data processing unit (3), computing actual values of the tolerances existing at the detected vehicles (5.1-5.6) from the stored condition data, and determining generally valid variables of the component or assembly sizing on the basis of the actual values for the particular vehicle type (5).

15. The method of claim 14, wherein the data processing unit (3) accesses production data related to the vehicle type (5) while determining the generally valid variables of the component or assembly sizing.

16. The method of claim 14, wherein the data processing unit (3) accesses technical data of supplied components or assemblies related to the vehicle type (5) while determining the generally valid variables of the component or assembly sizing.

17. The method of claim 14, wherein the data processing unit (3) accesses technical setting data related to the vehicle type (5) while determining the generally valid variables of the component or assembly sizing.

18. The method of claim 14, wherein the data processing unit (3) accesses workshop and service data related to the vehicle type (5) while determining the generally valid variables of the component or assembly sizing.

19. The method of claim 14, wherein the data processing unit (3) accesses test stand data related to the vehicle type (5) and data from type-specific test series while determining the generally valid variables of the component or assembly sizing.

20. The method of claim 14, wherein the data processing unit (3) accesses data regarding the production period and the production lot related to individual motor vehicles (5.1-5.6) of the vehicle type (5) while determining the generally valid variables of the component or assembly sizing.

21. The method of claim 14, wherein the data processing unit (3) accesses data regarding the running period or the operating hours of the motor vehicle (5.1-5.6) related to individual motor vehicles (5.1-5.6) of the vehicle type (5) while determining the generally valid variables of the component or assembly sizing.

22. The method of claim 14, wherein the data processing unit (3) accesses technical setting data related to individual motor vehicles (5.1-5.6) of the vehicle type (5) while determining the generally valid variables of the component or assembly sizing.

23. The method of claim 14, further comprising transmitting operation settings from the central computer (1) or the cloud (2) to individual vehicles (5.1-5.6) via the existing, wireless communication paths in order to implement or change operation settings at the motor vehicles (5.1-5.6).

24. The method of claim 23, wherein a release function is accessed prior to implementing or changing the operation settings, a vehicle user having access to the release function.

25. The method of claim 24, wherein the vehicle user has access to the release function via an app.

26. A system for determining tolerances of components or assemblies, comprising:
capturing means for at least periodically monitoring the components or assemblies of motor vehicles (5.1-5.6) of the same type during a driving operation and for metrologically gathering condition data (10) characteristic for tolerances at the components or assemblies;
a data transmission unit configured for transmitting the condition data (10) to a central computer (1) or a cloud (2) via existing, wireless communication paths, the condition data (10) stored in the central computer (1) or the cloud (2) together with a specific identifier for the individual motor vehicle (5.1-5.6); and
a data processing unit (3) configured for analyzing the stored condition data, computing actual values of the tolerances existing at the detected motor vehicles (5.1-5.6) from the stored condition data, and determining generally valid variables of the component or assembly sizing on the basis of the actual values for the particular vehicle type (5).
